(19) United States
(12) Patent Application Publication
(10) Pub. No.: US 2017/0137123 A1
(43) Pub. Date: May 18, 2017

(54) System, Apparatus and Methods for an Airspace Plane with Shockwave Piercing Wings

(71) Applicant: Charl E. Janeke, Los Angeles, CA (US)

(72) Inventor: Charl E. Janeke, Los Angeles, CA (US)

(21) Appl. No.: 15/355,010

(22) Filed: Nov. 17, 2016

Related U.S. Application Data
(60) Provisional application No. 62/256,315, filed on Nov. 17, 2015.

(51) Int. Cl. B64C 30/00; B64C 21/02; B64C 39/08

(52) U.S. Cl. CPC B64C 30/00; B64C 39/08; B64C 21/02; B64C 2230/08

(57) ABSTRACT

A system, apparatus and methods for an airspace plane with shockwave piercing leading edge slots has been described. Which mainly combines concepts of thermodynamic sequencing, heat transfer dynamics, boundary layer separation, spatial adaptivity and Carnot conformance. Wherein the leading-edge slots may be thermally conductive and have converging or diverging double decker structures.

### CROSS REFERENCE TO RELATED APPLICATIONS

This application claims the benefit of U.S. Provisional Patent Application No. 62/256,315 filed Nov. 17, 2015, which is incorporated herein by reference in its entirety.

### FIELD

The present inventive subject matter relates to a method and apparatus for an airspace plane with supersonic double decker wings.

### BACKGROUND

Blots represent an acronym for Busemann (biplane) leading edge slats. The Busemann (biplane) constitutes an historic isentropic (perfectly reversible) supersonic (double) wedge postulation whereby the incipient shockwave is being refracted between the two wedges and rexpanded to its original (supersonic) state in perfect harmony. Because of semblance to the (1935) BIPLANE state of the art, the Busemann hypothesis is modernly being perpetuated as a supersonic “Biplane” platform. By postulating the Blots as (micro) slots on the leading edge of a supersonic wing, shockwave formation may be suppressed in totality by reconfiguring the Blots as (1) diverging wedges (2) a throttling ramp (3) regenerative heat exchanger whereby the Blots will be transformed into a (powerful) Joule-Thomson refrigeration engine that enables isothermal compression of the incipient shock front that drives the (throttling) Joule-Thomson refrigeration engine conversely. However, because of the diverging Blots wedges, the incipient shock front is additionally pared/Switched into two conjunctively disjointed (diverging) supersonic potential fields enveloping the appurtenant wing/leading edge into a zero (Mach Number) stagnation wedge/depression/singularity.

Because (1) isothermal compression constitutes a singularity and (2) because isothermal compression defaults into a wildly gyrating (harmonic) process the Blots may consequently by development be transformed into (complex/imaginary) Carnot refrigeration engine whereby the wildly gyrating stagnation surges are being transformed in accordance with the Ideal Gas Law whereby T2/T1=(p2/p1)̂(k−1)/k which renders 10/20/30/40/50× (stochastic) stagnation pressure surges=1.9/2.4/2.6/2.9/3.1× (i.e. 66/83/90/100/107 C absolute temperature swings/surges @20% transformation efficacy in conformance with May/2011 “VT4” (Virginia Tech (cryogenic) shockwave piercing (regression) tests) that penetrates the ambient oxygen saturation zone regressively outside the cryogenic zone and hence develops into a full-blown Carnot (cryogenic) refrigeration engine.

In order to mitigate shockwave impediment with future supersonic platforms, A. Busemann invented the Busemann-Biplane postulation in 1935 whereby a leading shockwave is immediately expanded after formation within a wedged choke aperture. In accordance with the classical PRANDTL-MEYER theorem;

$$v = {[ \sqrt{\frac{γ + 1}{γ - 1}} \cdot {tan}^{- 1} \sqrt{\frac{γ - 1}{γ + 1} \cdot ( {M}^{2} - 1 )} - {tan}^{- 1} \sqrt{( {M}^{2} - 1 )} ]}_{{M}_{2}}^{{M}_{1}}$$

the Busemann-Biplane would recover 61.7% of the stagnation potential @Mach-2, however chilling the exit temperature marginally as a consequence of the two-step (Prandtl-Meyer) compression/expansion Busemann conformance.

The dynamics of Busemann leading edge slot as Mach 2/3/4 interceptor platform is being demonstrated as follows. In accordance with the laws of thermodynamics the work of compression wi=RT×ln(pr)=2.7×ln(2/3/4)=2.7×(0.89/1.1/1.39)=2.4/3.0/3.74 Btu/lb at Mach-3 @400R. Given hence a 12×½″ BLOTS aperture, the (BLOTS) mass flow=1×0.5× (1100×3)/100/12=0.1375 lb/sec @M3. The work of compression therefore=0.1375×RT/788×ln(10.3)=0.1375×27×2.33=8.7 Btu/sec. Given hence ⅛″ Aluminum nozzle liners, the regenerative BLOTS cooling power=A×k×ΔT/ΔL/3600=2/8/12×125×200/0.25/3600=0.58 Btu/sec. At ¼″ nozzle liners the regenerative (isothermal) cooling power=0.58×2=1.16 Btu/sec. At ½″ the regenerative cooling power=0.58×4=2.32 Btu/sec. Compare the isentropic work of expansion (k/(k−1))×RT×((pr)̂((k−1)/k)−1)=3.5×27×(10.8̂0.286−1)=92 Btu/lb/sec=12.7 Btu/sec @0.1375 lb/sec BLOTS mass flow.

The incipient/normal shockwaves are (1) being isothermally compressed and (2) re-expanded in a diverging/throttling aperture, real time BLOTS requires configuring the BLOTS aperture and heat conductive liners in conformance with the CARNOT sink and source heat exchange dynamics in accordance conductive flux Q=kA(Δt/Δx), where Q=isothermal work of compression, k=conductivity of the BLOTS liner, Δt=Joule-Thomson throttling potential and Δx=ΔL=thermal flux path length between inlet/compression and outlet/expansion/flashing apertures.

### SUMMARY

The present inventive subject matter describes a system, apparatus and methods for an airspace plane having wings with shockwave piercing Busemann BLOTS or leading edge slats. Which mainly combines concepts of thermodynamic sequencing, heat transfer dynamics, boundary layer separation, spatial adaptivity and Carnot (BLOTS/CLOTS) conformance.

These and other embodiments are described in more detail in the following detailed descriptions and the figures. The foregoing is not intended to be an exhaustive list of embodiments and features of the present inventive subject matter. Persons skilled in the art are capable of appreciating other embodiments and features from the following detailed description in conjunction with the drawings.

### DESCRIPTION OF DRAWINGS

FIG. 1 shows an airspace plane with leading edge slots.

FIG. 2 shows a wing cord with double-decker leading edge slots.

FIG. 3 shows a wing cord with (thermally conductive) diverging double-decker leading edge slots.

FIG. 4 shows a thermally conductive converging-diverging double-decker leading edge slot set.

FIG. 5 shows an airspace plane wing subjected to a supersonic adiabatic shockwave

FIG. 6 depicts an airspace plane wing with a truncated isentropic and Blots

FIG. 7 depicts an airspace plane wing with grooves on Busemann leading edge slats.

FIG. 8 depicts an airspace plane wing with an adjustable truncated/(isentropic) BLOTS

FIG. 9 depicts an airspace plane wing with ducted BLOTS (Busemann leading edge slats) with an adjustable/steerable discharge nozzle.

### DETAILED DESCRIPTION

In the following description, numerous specific details are set forth such as examples of specific materials, methods, components, etc. in order to provide a thorough understanding of the present inventive subject matter. It will be apparent, however, to one skilled in the art that these specific details need not be employed to practice the present invention. In other instances, well-known materials or methods have not been described in detail in order to avoid unnecessarily obscuring the present inventive subject matter.

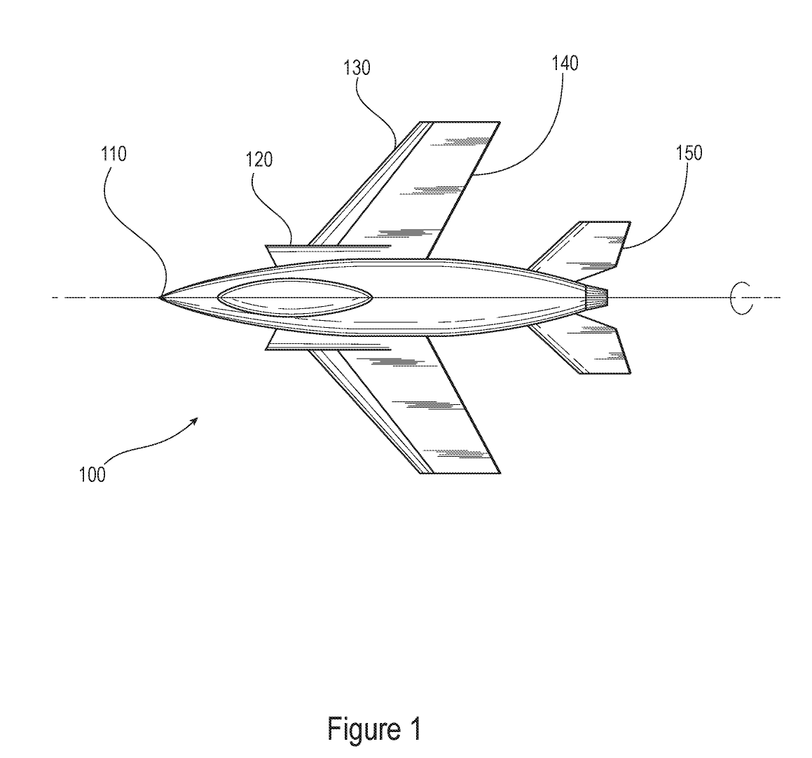

Now referring to Referring to FIG. 1, 100 describes an airspace plane with leading edge slats. 110 shows the nosecone of the fighter jet, 120 shows supersonic air intakes, 130 shows the leading-edge slots, 140 shows the wing and 150 shows the horizontal stabilizers.

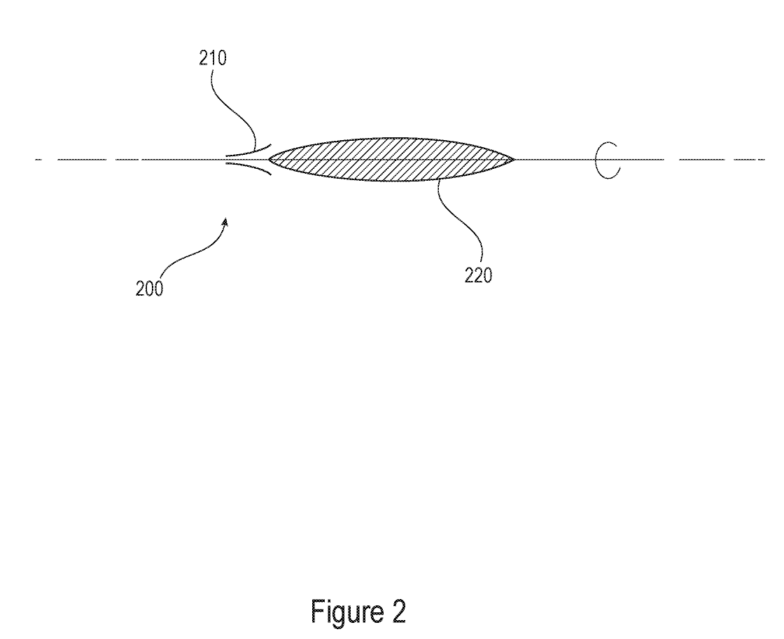

Now referring to FIG. 2, 200 illustrates the double-decker leading edge slats and 210 the wing cord. In accordance with the BLOT (Busemann Leading edge slots) claim the double-decker slats will act as a supersonic (shockwave) throttle/choke whereby refraction/expansion pressure waves will throttle/choke the incipient shockwave/shock front.

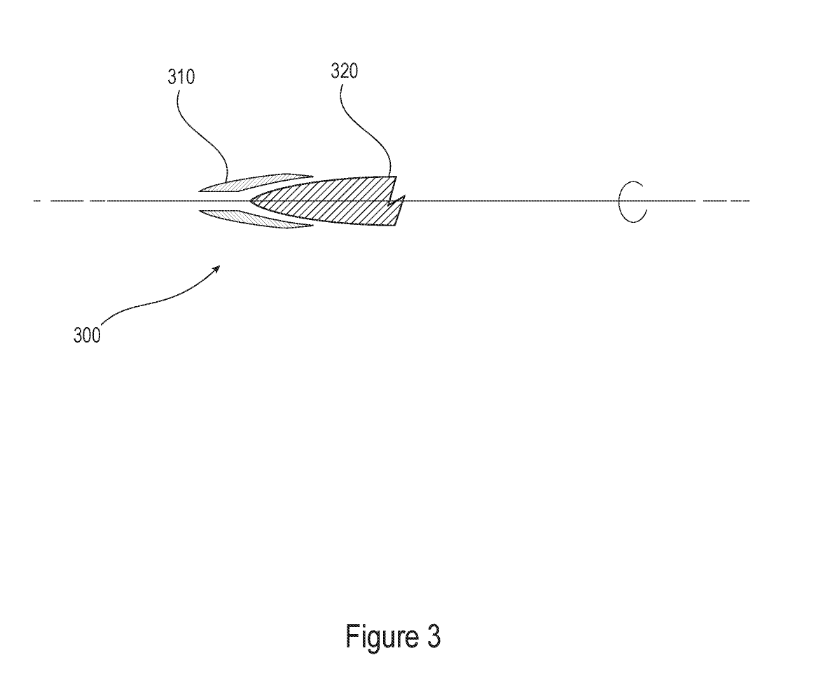

Now referring to FIG. 3, 300 illustrates the thermally conductive diverging double-decker leading edge slats 310 and the frontal wing cord 320. In accordance with the BLOTS (Busemann Leading edge slots) claim the (thermally conductive) diverging double-decker slats will act as (1) a CARNOT refrigeration engine due to regenerative expansion in the diverging (BLOTS) nozzle section (2) a regenerative heat exchanger between the diverging expansion nozzle and (BLOTS) intake aperture and (3) means of cooling/chilling in support of isothermal compression of the supersonic shock front (that preserves stagnation pressure).

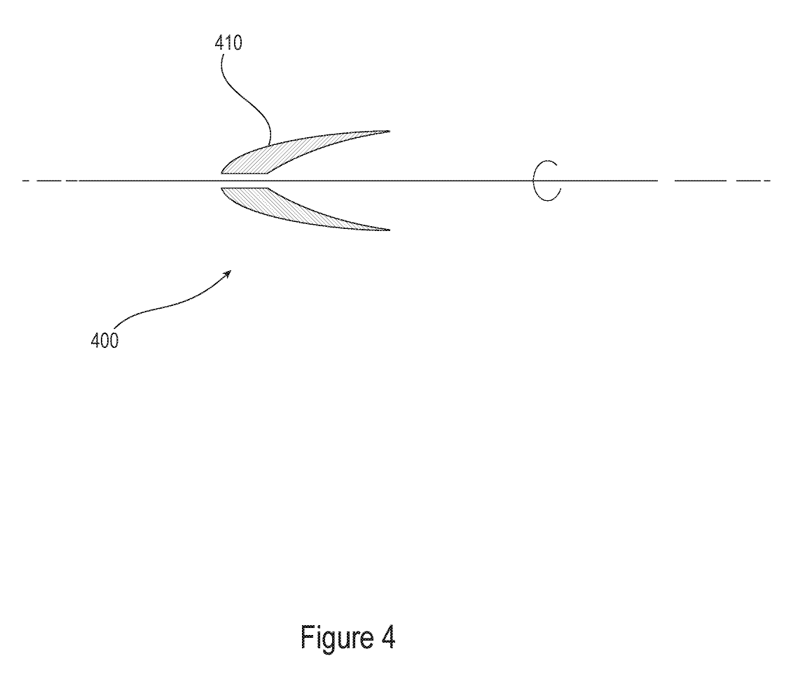

Now referring to FIG. 4, 400 shows the converging-diverging double-deckers slats 410 succinctly scaled to a ¼″ (choke) with a ½″ intake aperture expanding to 6″ to accommodate the frontal wing cord.

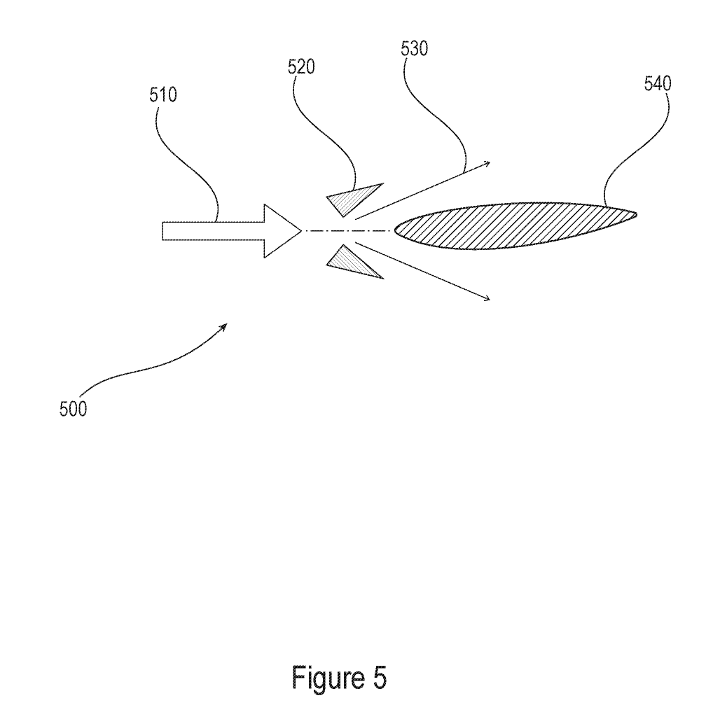

Now referring to FIG. 5, 500 illustrates the impact of BLOTS (Busemann leading edge) wedges whereby upon asymmetrical BLOTS (Busemann leading edge wedges) separates the incipient supersonic flux 510 is split/switched by BLOTS 520 into supersonic streams 530 around airspace plane wing 540.

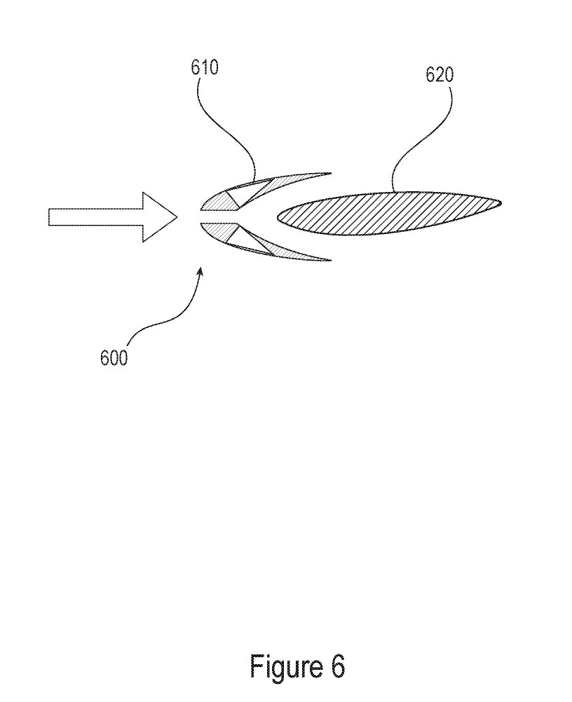

Now referring to FIG. 6, 600 illustrates an airspace plane wing 620 with isentropic BLOTS (Busemann leading edge wedges) 610 (whereby the incipient shockwave is being refracted between the two wedges and re-expanded to its original (supersonic) state in perfect harmony).

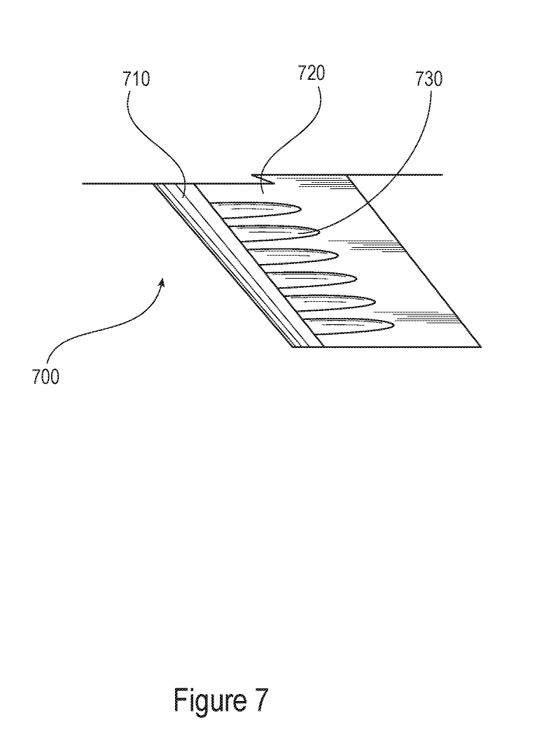

Now referring to FIG. 7, 700 illustrates an airspace plane wing with BLOTS (Busemann leading edge slots) 710 whereby the airspace plane wing 720 is equipped with fluted, splined, wedged or double wedged structures 730.

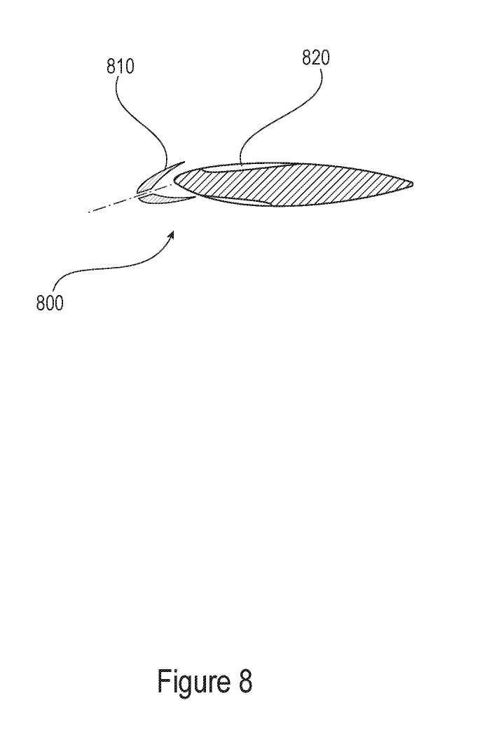

Now referring to FIG. 8, 800 illustrates an airspace plane wing 820 with adjustable isentropic BLOTS (Busemann leading edge slots) 810 tilted downwards into the incoming supersonic front morphing conventional SLATS purpose. Additionally, the BLOTS could be equipped with a vortex discharge shaft.

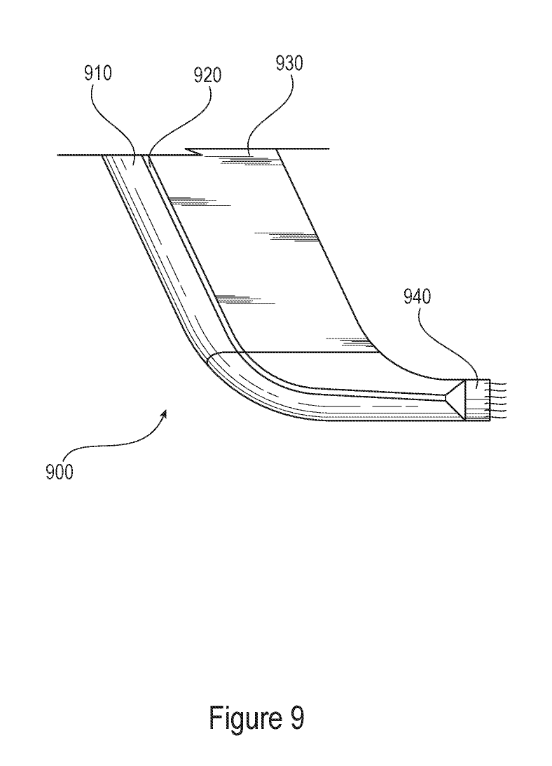

Now referring to FIG. 9, 900 illustrates an airspace plane wing 930 with asymmetrical isothermal compression BLOTS (Busemann leading edge slots) 910 and vortex discharge shaft 920 leading into adjustable isoentropically switched vortex nozzle 940. The vortex discharge shaft could lead to a centripetally thrust augmented scram rocket with isentropic thrust augmentation switch.

An airspace plane with wings having thermally reactive leading edge slots is being described as the inventive subject matter. Whereby the slots are converging/diverging Busemann conforming wedges. In the case of the converging Busemann wedge the supersonic front is isothermally compressed. In addition to this in the case of the diverging Busemann wedge the supersonic front expands isentropically in the diverging section which brings about a supersonic cooling or chilling effect (the Carnot engine synthesis) on the Busemann wedge. This process further instills a isothermal compression of the supersonic flux as a condition of optimality leading to refrigerated chilling in turn leading to the cryogenic zone. As this happens a portion of the ambient oxygen is liquefacted in the converging Busemann aperture followed by the evaporation of the liquefacted oxygen in part or totality concurrent with isentropic expansion in the diverging Busemann aperture. The whole process of compression/liquefaction/flashing conforms as a Carnot refrigeration engine/cycle with the supersonic front the engine and liquefaction and flashing the upper and lower heat sinks, whereby isothermal compression, isentropic expansion and liquefaction/flashing of the supersonic front is limited to boundary layer in contact with the Busemann slots. And also, Carnot conformance may be predicated on the absolute temperature of the upper/lower heat sinks (i.e. isothermal compression and isentropic expansion) in lieu of the latent heat of condensation/evaporation of ambient oxygen;

Busemann shockwave piercing leading edge BLOTS/SLOTS, Carnot conformance is consequently imbedded into the master computational flight management gain algorithm as principal shockwave piercing and SSTO conformance denominator in lieu of simplistic stagnation pressure as the controlling dynamic condition of state. The Carnot cycle is imbedded in the stochastic optimal gain computation algorithm. Further the Carnot cycle is imbedded in a DP (Dynamic Programming) optimal (predictive) computational kernel in sync with the stochastic optimal gain computation algorithm as the condition of optimality. Whereby Carnot performance (in lieu of stagnation pressure in isolation) functions as is the controlling (Dynamic Programming) optimal predictive denominator. The propellant resource represents the cost/feasibility denominator in pursuit of Carnot optimality in the (Dynamic Programming) optimal predictive denominator. And also, the leading-edge slots are spatially configured as conical/circular converging/diverging Busemann conforming wedges.

In accordance with the elemental (isentropic) Busemann (“Bi-plane”) refractive shockwave compression/expansion postulation FIGS. 5/6, the leading shockwave is immediately upon formation (refracted) and (re)expanded in perfect sync with the leading (supersonic) conditions. In its native format the elemental (isentropic) Busemann shockwave (refraction) postulation represented a supersonic biplane wing free of shockwave formation (however also a (zero-lift) non-event flying-machine event.

Modernly however (instant) “BLOTS” art is best configured as a (supersonic) shockwave abatement (isentropic) leading edge slots. However because perfectly reversible (isentropic) expansion is in conflict with the 2nd Law of thermodynamics and because shockwave formation will nonetheless replicate on the leading edge of a (BLOTS) Busemann leading edge slats transformed (supersonic) wing, the BLOTS are, reconfigured into an asymmetric diverging refraction ramp (#2) that spawns Joule-Thomson (throttling) that turns the asymmetric diverging (BLOTS) refraction ramp into a powerful Joule-Thomson refrigeration engine.

However, because of the diverging BLOTS configuration the exit/leaving supersonic flux is paired/switched into two conjunctively independent (diverging) supersonic potential fields with a zero Mach/stagnation wedge/depression/singularity enveloping the appurtenant BLOTS (wing) leading edge.

By consequently configuring the asymmetric diverging (Joule Thomson) refraction ramp out of a super conductive material (copper/aluminum/graphite/nanocarbon), isothermal compression of the incipient shock front may be morphed into isothermal compression flux whereby the sub/super/hypersonic kinetic potential is being preserved by driving the Joule-Thomson throttling/expansion refrigeration synthesis.

As isothermal compression constitutes a singularity and the enabling BLOTS is a stochastic flux, it is necessary to reinstate the condition ante by switching the “wildly gyrating” stochastic flux back into the native isentropic domain via the instant (isentropic) flutes or splines or wedges switch facilitations. An airspace plane with wings having leading edge slots; the leading edge, slots further being; thermally reactive; and configured as double-decker wedges. The airspace plane wherein the slots are converging double-decker wedges. The airspace plane wherein the slots are diverging double-decker wedges. The airspace plane wherein the leading-edge slots functions/conforms as a Joule-Thompson refrigeration engine driven by the kinetic (stagnation) pressure front in the ambient zone. The airspace plane wherein the leading-edge slots conform as a Carnot refrigeration engine driven by isothermal compression within the cryogenic zone. The airspace plane wherein the Busemann leading edge slots are thermally (color selective) coated to augment black bulb radiation coupling between the incipient hypersonic front and the slots aperture. The airspace plane wherein the black bulb radiation coupling spawns/drives/facilitates/enables isothermal compression of the incipient hypersonic front by dissipation heat of compression spatially. The airspace plane wherein the Busemann leading edge slots defaults into a Carnot refrigeration engine upon contact of/with the isothermally compressed hypersonic front. The airspace plane wherein the Busemann leading edge slots acts as a hypersonic Boltzman black-bulb switch. The airspace plane wherein the slots acts as a hypersonic stochastic switch. The airspace plane wherein an exit aperture of the BLOTS Busemann hypersonic slots are fluted or grooved or splined. The airspace plane wherein the Busemann leading edge slots acts as a hypersonic isentropic rectifier switch.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

1. An airspace plane with wings having leading edge slots; the leading edge slots further being;
thermally reactive; and
configured as double-decker wedges.

2. The airspace plane as described in claim 1, wherein the slots are converging double-decker wedges.

3. The airspace plane as described in claim 1, wherein the slots are diverging double-decker wedges.

4. The airspace plane described in claim 1 wherein the leading edge slots functions/conforms as a Joule-Thompson refrigeration engine driven by the kinetic (stagnation) pressure front in the ambient zone.

5. The airspace plane described in claim 4 wherein the leading edge slots conform as a Carnot refrigeration engine driven by isothermal compression within the cryogenic zone.

6. The airspace plane described in claim 1, wherein the Busemann leading edge slots are thermally (color selective) coated to augment black bulb radiation coupling between the incipient hypersonic front and the slots aperture.

7. The airspace plane described in claim 1, wherein the black bulb radiation coupling spawns/drives/facilitates/enables isothermal compression of the incipient hypersonic front by dissipation heat of compression spatially.

8. The airspace plane described in claim 1, wherein the Busemann leading edge slots defaults into a Carnot refrigeration engine upon contact of/with the isothermally compressed hypersonic front.

9. The airspace plane described in claim 1, wherein the Busemann leading edge slots acts as a hypersonic Boltzman black-bulb switch.

10. The airspace plane described in claim 1, wherein the slots acts as a hypersonic stochastic switch.

11. The airspace plane described in claim 1, wherein an exit aperture of the BLOTS Busemann hypersonic slots are fluted or grooved or splined.

12. The airspace plane described in claim 1, wherein the Busemann leading edge slots acts as a hypersonic isentropic rectifier switch.
